(19) United States
(12) Patent Application Publication
(10) Pub. No.: US 2018/0014371 A1
(43) Pub. Date: Jan. 11, 2018

(54) LED Direct Current Control Circuit

(71) Applicant: LUSTROUS TECHNOLOGY LTD, New Taipei City (TW)

(72) Inventor: Chin-Der WEY, New Taipei City (TW)

(73) Assignee: LUSTROUS TECHNOLOGY LTD

(21) Appl. No.: 15/242,761

(22) Filed: Aug. 22, 2016

(30) Foreign Application Priority Data
Jul. 5, 2016 (TW) TW 105210121

(51) Int. Cl. H05B 33/08

(52) U.S. Cl. CPC H05B 33/0815; H05B 33/083; H05B 33/0845

(57) ABSTRACT

Disclosed is a LED DC control circuit that comprises an AC to DC circuit, a voltage division circuit, a controller and a logic circuit. The AC to DC circuit receives an AC reference voltage and generates a sine wave reference voltage and a DC reference voltage. The voltage division circuit receives the DC reference voltage and generates a threshold voltage. The controller compares the threshold voltage with the DC reference voltage to generate an inner reference voltage. The controller receives a first PWM voltage signal to accordingly sample the inner reference voltage and then output a second PWM voltage signal. The logic circuit receives the second PWM voltage signal to generate a driving voltage and a load current for driving a power switch circuit. Within each period of the sine wave reference voltage, at least one of the driving signals of the load current is a relative maximum.

### BACKGROUND OF THE INVENTION

### 1. Technical Field

The instant disclosure relates to a Light-Emitting Diode (LED) direct current (DC) control circuit; in particular, to a LED DC control circuit having a low sample rate.

### 2. Description of Related Art

Recently, LEDs have been widely used in illumination systems, and the alternating current (AC) power source has been chosen to be the power supply of more and more illumination systems. Traditionally, if the AC power source used as the power supply of an illumination system, a bridge-type rectifier executes a full-wave rectification for the input AC current, and then the rectified AC current is outputted to the LEDs.

The LED is a light source that is generated by a working mechanism related to the semiconductors. The LED is often used as an indicator of the electric meter having low power consumption or the home appliance. The LED has been commonly used in many kinds of illumination devices. For example, it has been used as the traffic light, the direction indicator and the brake light of vehicles or the like. The traditional incandescent lamps and the fluorescent lamps recently have been replaced with the LED lamp string. The characteristic curve of the LED, which indicates the relationship of the current and the voltage, is similar to a diode. If the voltage applied to the LED is less than a threshold voltage, there is only a minor current flowing through the LED. If the voltage applied to the LED is greater than the threshold voltage, the current that can flow through the LED dramatically increase. Generally, the luminescence intensity of the LED is proportional to the current flowing through the LED. However, if the current flowing through the LED is really large, it will be a different case. Generally, the driving device of an illumination device using the LEDs provides a constant current to make the LEDs emit light stably and to make the lifetime of the LEDs longer.

Comparing with the traditional light source, such as the incandescent lamp and the fluorescent lamp, the LED has advantages, such as the great lighting efficiency at a low temperature, being less contaminate, the longer lifetime and the like. The LED has gradually become a popular choice of the light source used in many kinds of illumination devices. Thus, there are more and more methods for controlling or adjusting the luminosity of the LED. Mostly, a dimmer module and a complex control circuit are used to make the LED flick, so that a user can find that the luminosity of the LED decreases because of the persistence of vision. However, in this manner, the user may feel uncomfortable because of seeing the LED flick too much. Moreover, the complex control circuit may increase the manufacturing cost of the illumination device.

### SUMMARY OF THE INVENTION

The instant disclosure provides a LED DC control circuit that is used to drive at least one LED lamp string. The LED DC control circuit comprises an AC to DC circuit, a voltage division circuit, a controller and a logic circuit. The AC to DC circuit receives an AC reference voltage and generates a sine wave reference voltage and a DC reference voltage. The voltage division circuit receives the DC reference voltage and generates a threshold voltage. The controller is electrically connected to the AC to DC circuit and the voltage division circuit, and compares the threshold voltage with the DC reference voltage to generate an inner reference voltage. The controller receives a first PWM voltage signal to accordingly sample the inner reference voltage and then to output a second PWM voltage signal. The logic circuit is electrically connected to the controller. The logic circuit receives the second PWM voltage signal to generate a driving voltage and a load current for driving a power switch circuit. Within each period of the sine wave reference voltage, there are a plurality of driving signals of the load current, and at least one of the driving signals is the relative maximum.

In one embodiment of the LED DC control circuit provided by the instant disclosure, the controller has a preset frequency, and the frequency of the second PWM voltage signal is determined by the preset frequency of the controller.

In one embodiment of the LED DC control circuit provided by the instant disclosure, the duty cycle of the second PWM voltage signal is determined by the duty cycle of the first PWM voltage signal.

In one embodiment of the LED DC control circuit provided by the instant disclosure, the inner reference voltage is larger than the threshold voltage.

To sum up, the LED DC control circuit provided by the instant disclosure supplies a direct current with a low power consumption because of the circuit configuration is stable and has a high performance, and thus the power loss during the voltage conversion can be reduced.

In addition, in the LED DC control circuit provided by the instant disclosure, within each period of the sine wave reference voltage, there are a plurality of driving signals of the load current, and at least one of the driving signals is the relative maximum, which makes the LED flick less.

For further understanding of the instant disclosure, reference is made to the following detailed description illustrating the embodiments of the instant disclosure. The description is only for illustrating the instant disclosure, not for limiting the scope of the claim.

### BRIEF DESCRIPTION OF THE SEVERAL VIEWS OF THE DRAWINGS

FIG. 1 shows a block diagram of a LED DC control circuit of one embodiment of the instant disclosure.

FIG. 2 shows a circuit diagram of a LED DC control circuit of another embodiment of the instant disclosure.

FIG. 3 shows a waveform diagram of a LED DC control circuit of another embodiment of the instant disclosure.

FIG. 4 shows a waveform diagram of a LED DC control circuit of another embodiment of the instant disclosure.

FIG. 5 shows a waveform diagram of the load current of a LED DC control circuit of another embodiment of the instant disclosure.

### DETAILED DESCRIPTION OF THE EMBODIMENTS OF THE INVENTION

The aforementioned illustrations and following detailed descriptions are exemplary for the purpose of further explaining the scope of the instant disclosure. Other objectives and advantages related to the instant disclosure will be illustrated in the subsequent descriptions and appended drawings.

It will be understood that, although the terms first, second, third, and the like, may be used herein to describe various elements, but these elements should not be limited by these terms. These terms are only to distinguish one element from another region or section discussed below could be termed a second element without departing from the teachings of the instant disclosure. As used herein, the term “and/or” includes any and all combinations of one or more of the associated listed items.

There are a plurality of embodiments provided for illustrating the LED DC control circuit, and how it can decrease the power loss during the voltage conversion and can make the LED flick less. The LED DC control circuit provided by the instant disclosure has a great reliability and a high luminosity.

[One Embodiment of the LED DC Control Circuit]

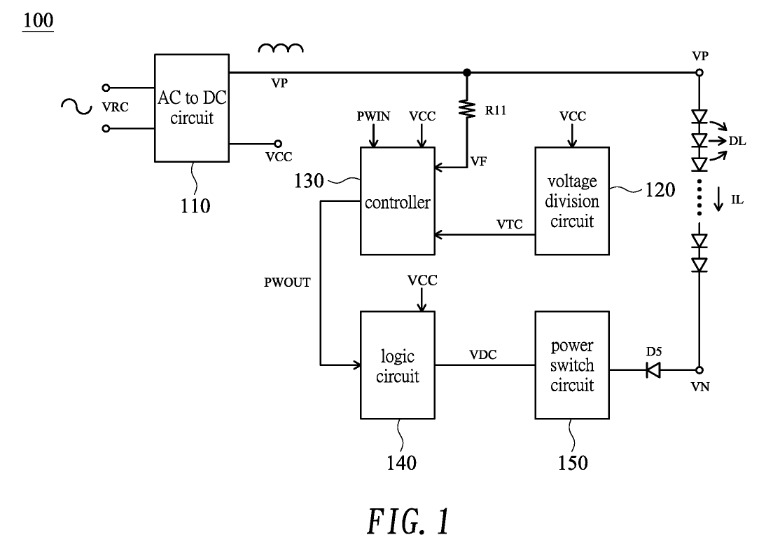

Referring to FIG. 1, FIG. 1 shows a block diagram of a LED DC control circuit of one embodiment of the instant disclosure. As shown in FIG. 1, the LED DC control circuit 100 for driving at least one LED lamp string DL comprises an AC to DC circuit 110, a voltage division circuit 120, a controller 130 and a logic circuit 140. The voltage division circuit 120 is electrically connected to the AC to DC circuit 110. The controller 130 is electrically connected to the AC to DC circuit 110 and the voltage division circuit 120. The logic circuit 140 is electrically connected to the controller 130 and a power switch circuit 150.

The AC to DC circuit 110 is configured to receive an AC reference voltage VRC from a commercial power. The AC to DC circuit 110 converts the AC reference voltage VRC and generates a sine wave reference voltage VP and a stable DC reference voltage VCC. The DC reference voltage VCC is provided to each circuit block of the instant disclosure.

The voltage division circuit 120 can be, for example, a resistive voltage division circuit. The voltage division circuit 120 receives the DC reference voltage VCC, and divides the DC reference voltage VCC by its resistors to generate a threshold voltage VTC.

The controller 130 receives the threshold voltage VTC and the DC reference voltage, and then compares the threshold voltage VTC with the DC reference voltage to generate an inner reference voltage (not shown in FIG. 1). It is worth mentioning that, the inner reference voltage is larger than the threshold voltage VTC.

The logic circuit 140 is configured to receive a second PWM voltage signal PWOUT to generate a driving voltage VDC and a load current IL, and then the power switch circuit 150 is accordingly driven.

The voltage conversion device is widely used to convert a high-voltage power to a low-voltage power, and then this low-voltage power can be provided to one or more LED illumination devices. However, the voltage conversion device may decrease the performance of the LED illumination device and increase the cost of the LED illumination device. In addition, because of the voltage conversion device used in the LED illumination device, the LED illumination device may have a large volume. Thus, the instant disclosure is to improve the performance of the LED illumination device.

The following description is to further illustrate the working mechanism of the LED DC control circuit 100.

To begin with, the LED DC control circuit 100 converts an AC reference voltage VRC to a sine wave reference voltage VP, and further converts the sine wave reference voltage VP to a DC reference voltage VCC by the AC to DC circuit 110. The configuration of the LED DC control circuit 100 has a great liability, and the LED DC control circuit 100 can provide a DC current with a low power loss. The sine wave reference voltage VP is lowered by a transistor R11 and then is transmitted to the controller 130. After that, the controller 130 receives a first PWM voltage signal PWIN to sample the inner reference voltage with a low sample rate and then outputs a second PWM voltage signal PWOUT. For example, the sample rate of the controller 130 is from 45 Hz to 1 kHz.

It should be noted that, the controller 130 has a preset frequency, such as 360 Hz. The frequency of the second PWM voltage signal PWOUT is determined by the preset frequency of the controller 130. The duty cycle of the second PWM voltage signal PWOUT is determined according to the duty cycle of the first PWM voltage signal PWIN. Within each period of the sine wave reference voltage VP, there are a plurality of driving signals of the load current IL. For example, there may be three, five or seven driving signals, and at least one of the driving signals is the relative maximum, which makes the LED DL flick less. The driving signal that is the relative maximum among the driving signals of the load current IL has a larger amplitude than the amplitudes of other driving signals of the load current IL.

In the following embodiments, there are only parts different from embodiments in FIG. 1 described, and the omitted parts are indicated to be identical to the embodiments in FIG. 1. In addition, for an easy instruction, similar reference numbers or symbols refer to elements alike.

[Another Embodiment of the LED DC Control Circuit]

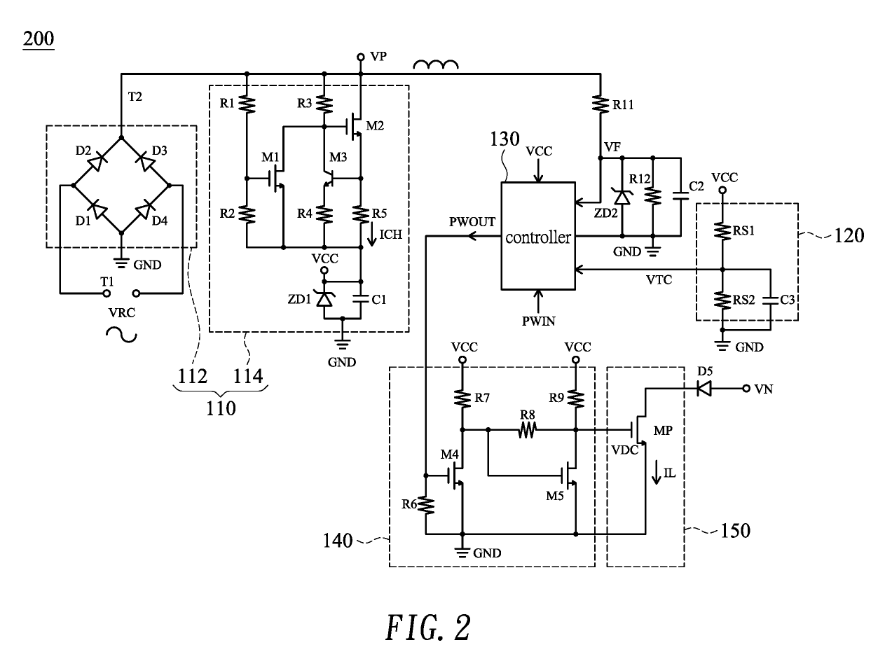

Referring to FIG. 2, FIG. 2 shows a circuit diagram of a LED DC control circuit of another embodiment of the instant disclosure. As shown in FIG. 2, the AC to DC circuit 110 comprises a rectifying circuit 112 and a reference voltage generating circuit 114. The reference voltage generating circuit 114 comprises a first resistor R1, a second resistor R2, a first transistor M1, a third resistor R3, a second transistor M2, a third transistor M3, a fourth resistor R4, a fifth resistor R5, a first capacitor C1 and a Zener diode ZD1. The logic circuit 140 comprises a sixth resistor R6, a fourth transistor M4, a seventh resistor R7, a eight resistor R8, a fifth M5 and a ninth resistor R9. The voltage division circuit 120 comprises divider resistors RS1, RS2 and C3.

The reference voltage generating circuit 114 is connected to the rectifying circuit 112. One end of the first resistor R1 is connected to the output end T2 of the rectifying circuit 112. One end of the second resistor R2 is connected to the other end of the first resistor R1. Gate of the first transistor M1 is connected to one end of the second resistor R2. Source of the first transistor M1 is connected to the other end of the second resistor R2. One end of the third resistor R3 is connected to one end of the first resistor R1. Gate of the second transistor M2 is connected to the other end of the third resistor R3, and drain of the second transistor M2 is connected to one end of the third resistor R3. Collector of the third transistor M3 is connected to the other end of the third resistor R3, and base of the third transistor M3 is connected to source of the second transistor M2.

One end of the fourth resistor R4 is connected to emitter of the third transistor M3, and the other end of the fourth resistor R4 is connected to the other end of the first resistor R2. One end of the fifth resistor R5 is connected to base of the third transistor M3, and the other end of the fifth resistor R5 is connected to the other end of the fourth resistor R4. One end of the first capacitor C1 is connected to the other end of the fifth resistor R5. Anode of the Zener diode ZD1 is connected to the other end of the first capacitor C1 and a grounding end GND, and cathode of the Zener diode ZD1 is connected to one end of the first capacitor C1. One end of the sixth resistor R6 is connected to the controller 130, and the other end of the sixth resistor R6 is connected to the grounding end GND. Gate of the fourth transistor M4 is connected to one end of the sixth resistor R6, and source of the fourth transistor M4 is connected to the grounding end GND. The other end of the seventh resistor R7 is connected to drain of the fourth transistor M4. One end of the eighth resistor R8 is connected to the other end of the seventh resistor R7. Gate of the fifth transistor M5 is connected to one end of the eighth resistor R8, source of the fifth transistor M5 is connected to the grounding end GND, and drain of the fifth transistor M5 is connected to the other end of the eighth resistor R8 and gate of the power switch transistor MP. Source of the power switch transistor MP is connected to the grounding end GND. Drain of the power switch transistor MP is connected to the cathode of the diode D1. The other end of the ninth resistor R9 is connected to drain of the fifth transistor M5.

The following description is to further illustrate the working mechanism of the LED DC control circuit 200.

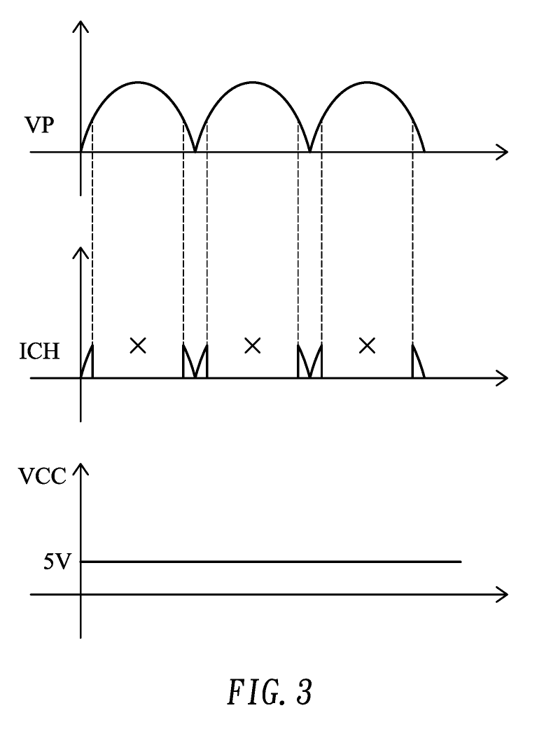

In conjunction with FIG. 2 and FIG. 3, FIG. 3 shows a waveform diagram of a LED DC control circuit of another embodiment of the instant disclosure. The rectifying circuit 112 is a full-wave rectifying circuit that has diodes D1, D2, D3 and D4. The connection relationship of the diodes D1, D2, D3 and D4 is shown in FIG. 2. The input end T1 of the rectifying circuit 112 receives an AC reference voltage VRC, the rectifying circuit 112 executes a full-wave rectification for the AC reference voltage VRC, and then a sine wave reference voltage VP is generated from the output end T2 of the rectifying circuit 112. After that, the LED DC control circuit 200 processes the sine wave reference voltage VP by the reference voltage generating circuit 114 to generate a stable DC reference voltage VCC. Specifically speaking, the amplitude of the sine wave reference voltage VP varies with different ratios of the first resistor R1 and the second resistor R2. The time duration when the first transistor M1 is turned on and the time duration when the first transistor M1 is turned off are determined by the ratio of the first resistor R1 and the second resistor R2. Thus, the current value of the charging current ICH can be determined by the time duration when the first transistor M1 is turned on and the time duration when the first transistor M1 is turned off.

When the sine wave reference voltage VP increases and then become sufficient to turn on the transistor M1, gate and source of the second transistor M2 form a short circuit, such that the second transistor M2 is turned off and the current value of the charging current ICH is zero. On the other hand, if the sine wave reference voltage VP is still too low to turn off the transistor M1, the second transistor M2 is turned on and there is a charging current ICH of which the waveform diagram is shown by FIG. 3. ADC reference voltage VCC is generated after the first capacitor C1 is charged by the charging current ICH. The DC reference voltage VCC is, for example, 5V. In this manner, the LED DC control circuit 200 can supply a direct current with a low power consumption, and thus the power loss during the voltage conversion can be reduced.

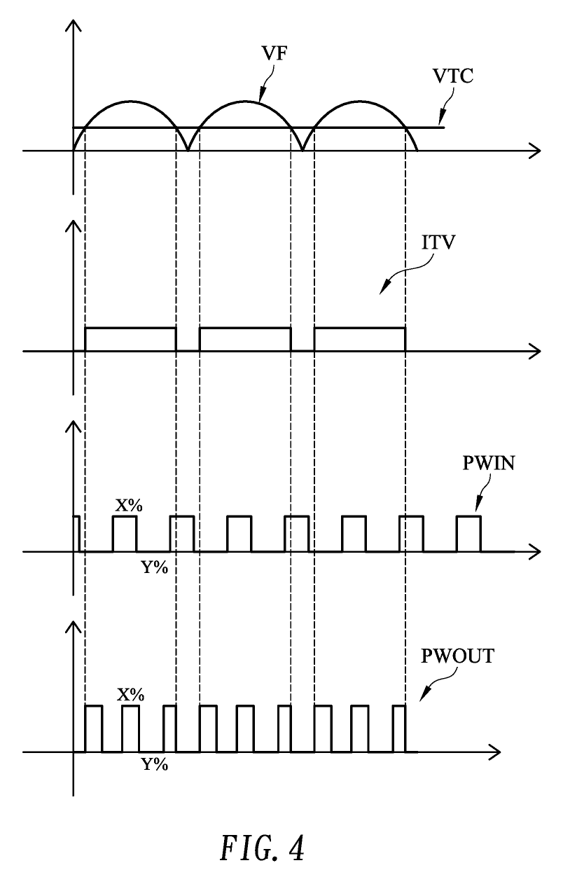

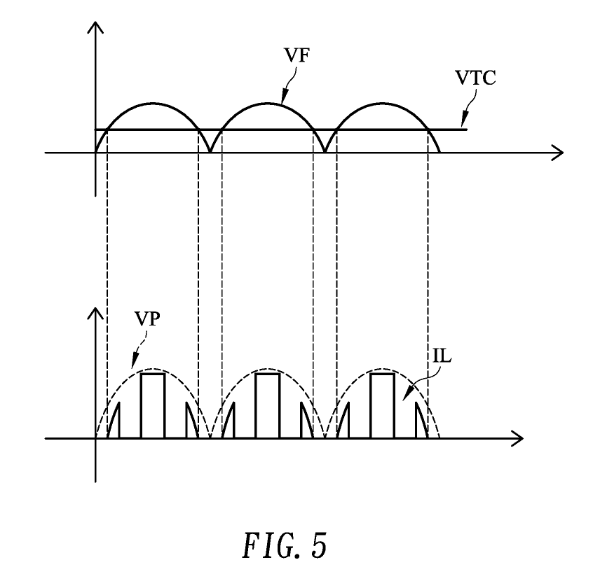

Referring to FIG. 2, FIG. 4 and FIG. 5, FIG. 4 shows a waveform diagram of a LED DC control circuit of another embodiment of the instant disclosure, and FIG. 5 shows a waveform diagram of the load current of a LED DC control circuit of another embodiment of the instant disclosure. After receiving the threshold voltage VTC and the sine wave reference voltage VP that has been lowered by the resistor R11, the controller 130 compares the threshold voltage VTC and the sine wave reference voltage VP to generate an inner reference voltage ITV. It should be noted that, the inner reference voltage ITV is larger than threshold voltage VTC. For example, the threshold voltage VTC can be 1V. Additionally, the controller 130 samples the inner reference voltage ITV by the first PWM voltage signal PWIN to generate a second PWM voltage signal PWOUT. In one embodiment, the amplitude of the relative maximum driving signal is twice larger than the amplitude of each of other driving signals.

The preset frequency of the controller 130 is preset by a designer, and the frequency of the second PWM voltage signal PWOUT is determined by the preset frequency of the controller 130, for example, 45 Hz-1 kHz. Thus, it can be known that, comparing with the traditional LED control circuit having a high sample rate, the sample rate of the LED DC control circuit 200 is low. Moreover, a designer can determine the duty cycle (X %:Y %) of the second PWM voltage signal PWOUT by setting the duty cycle (X %:Y %) of the first PWM voltage signal PWIN. For example, to make the duty cycle (X %:Y %) of the second PWM voltage signal PWOUT be 40%:60%, the designer can set the duty cycle (X %:Y %) of the first PWM voltage signal PWIN to be 40%:60%. In one embodiment, the first PWM voltage signal PWIN is transmitted to the controller 130 through an optical coupler (not shown in FIG. 2). It should be noted that, the waveform of the second PWM voltage signal PWOUT shown in FIG. 4 is a schematic waveform.

Then, the second PWM voltage signal PWOUT is received by gate of the fourth transistor M4 of the logic circuit 140. If the fourth transistor M4 is turned on, the fifth transistor M5 will be turned off, but if the fifth transistor M5 is turned on, the fourth transistor M4 will be turned off. In this manner, a driving voltage VDC is generated to continually drive the power switch transistor MP. When the power switch transistor MP is driven, a load current IL and an output voltage VN are generated, wherein at least one of the driving signals of the load current IL is a relative maximum driving signal within each period of the sine wave reference voltage VP. People will find that the LED lamp string flick less because of the persistence of vision. Moreover, the diode D5 is configured to prevent the reverse current.

To sum up, the LED DC control circuit provided by the instant disclosure supplies a direct current with a low power consumption because of the circuit configuration is stable and has a high performance, and thus the power loss during the voltage conversion can be reduced.

In addition, in the LED DC control circuit provided by the instant disclosure, within each period of the sine wave reference voltage, there are a plurality of driving signals of the load current, and at least one of the driving signals is the relative maximum, which makes the LED flick less.

The features of the present invention are disclosed above by the preferred embodiment to allow persons skilled in the art to gain insight into the contents of the present invention and implement the present invention accordingly. The preferred embodiment of the present invention should not be interpreted as restrictive of the scope of the present invention. Hence, all equivalent modifications or amendments made to the aforesaid embodiment should fall within the scope of the appended claims.

What is claimed is:

1. A LED DC control circuit, used to drive at least one LED lamp string, the LED DC control circuit comprising:
an AC to DC circuit, receiving an AC reference voltage and generating a sine wave reference voltage and a DC reference voltage;
a voltage division circuit, receiving the DC reference voltage and generating a threshold voltage;
a controller, electrically connected to the AC to DC circuit and the voltage division circuit, and comparing the threshold voltage with the DC reference voltage to generate an inner reference voltage, wherein the controller receives a first PWM voltage signal to accordingly sample the inner reference voltage and then output a second PWM voltage signal; and
a logic circuit, electrically connected to the controller, and receiving the second PWM voltage signal to generate a driving voltage and a load current for driving a power switch circuit;
wherein within each period of the sine wave reference voltage, there are a plurality of driving signals of the load current, and at least one of the driving signals is the relative maximum.

2. The LED DC control circuit according to claim 1, wherein the controller has a preset frequency, and the frequency of the second PWM voltage signal is determined by the preset frequency of the controller.

3. The LED DC control circuit according to claim 1, wherein the duty cycle of the second PWM voltage signal is determined by the duty cycle of the first PWM voltage signal.

4. The LED DC control circuit according to claim 1, wherein the AC to DC circuit comprises:
a rectifying circuit, receiving the AC reference voltage by its input end, executing a full wave rectification for the AC reference voltage, and generating the sine wave reference voltage from its output end; and
a reference voltage generating circuit, processing the sine wave reference voltage to generate the DC reference voltage.

5. The LED DC control circuit according to claim 4, wherein the reference voltage generating circuit comprises:
a first resistor, having one end connected to the output end of the rectifying circuit, and receiving the sine wave reference voltage;
a second resistor, having one end connected to the other end of the first resistor;
a first transistor, having gate connected to one end of the second resistor, and having source connected to the other end of the second resistor;
a third resistor, having one end connected to one end of the first resistor;
a second transistor, having gate connected to the other end of the third resistor and drain of the first transistor, and having drain connected to one end of the third resistor;
a third transistor, having collector connected to the other end of the third resistor, and having base connected to source of the second transistor;
a fourth resistor, having one end connected to emitter of the third transistor, and having the other end connected to the other end of the second resistor; and
a fifth resistor, having one end connected to base of the third transistor, and having the other end connected to the other end of the fourth resistor;
wherein when the first transistor is turned on, the second transistor is turned off, but when the first transistor is turned off, the second transistor is turned on, such that a charging current is generated.

6. The LED DC control circuit according to claim 5, wherein the time duration when the first transistor is turned on and the time duration when the first transistor is turned off are determined by the ratio of the first resistor and the second resistor, and the current value of the charging current is determined by the time duration when the first transistor is turned on and the time duration when the first transistor is turned off.

7. The LED DC control circuit according to claim 5, wherein the reference voltage generating circuit further comprises:
a first capacitor, having one end connected to the other end of the fifth resistor to receive the charging current, and generating the DC reference voltage; and
a Zener diode, having anode connected to the other end of the first capacitor and a grounding end, and having cathode connected to one end of the first capacitor.

8. The LED DC control circuit according to claim 1, wherein the power switch circuit is a power switch transistor, and the logic circuit comprises:
a sixth resistor, having one end connected to the controller, and having the other end connected to the a grounding end;
a fourth transistor, having gate connected to one end of the sixth resistor to receive the second PWM voltage signal, and having source connected to the grounding end;
a seventh resistor, having one end to receive the DC reference voltage, and having another end connected to drain of the fourth transistor;
an eighth resistor, having one end connected to the other end of the seventh resistor;
a fifth transistor, having gate connected to one end of the eighth resistor, having source connected to the grounding end, and having drain connected to the other end of the eight resistor and gate of the power switch transistor, wherein source of the power switch transistor is connected to the grounding end; and
a ninth resistor, having one end receiving the DC reference voltage, and having the other end connected to drain of the fifth transistor;
wherein when the fourth transistor is turned on, the fifth transistor is turned off, but when the fifth transistor is turned on, the fourth transistor is turned off, such that the power switch transistor is continually driven.

9. The LED DC control circuit according to claim 1, wherein the inner reference voltage is larger than the threshold voltage.
